(19) United States
(12) Patent Application Publication
(10) Pub. No.: US 2026/0162978 A1
(43) Pub. Date: Jun. 11, 2026

(54) ANODE MATERIALS FOR ELECTROCHEMICAL CELLS AND METHODS OF THEIR SYNTHESIS

(71) Applicant: Alsym Energy, Inc., Malden, MA (US)

(72) Inventors: Ashwin Chaturvedi, Burlington, MA (US); Jae Hyo-Han, Cambridge, MA (US); Kirk Hutchinson, Sudbury, MA (US); Matthew Williams, Woburn, MA (US)

(21) Appl. No.: 19/410,864

(22) Filed: Dec. 5, 2025

Related U.S. Application Data
(60) Provisional application No. 63/729,311, filed on Dec. 6, 2024.

(51) Int. Cl. H01M 4/485; C01G 41/00; H01M 4/02

(52) U.S. Cl. CPC H01M 4/485; C01G 41/00; C01P 2002/72; C01P 2004/03; C01P 2004/60; C01P 2006/40; H01M 2004/028

(57) ABSTRACT

Electroactive anode materials for energy storage devices and applications and electrodes comprising them are presented herein. Additionally, methods of manufacturing such materials are disclosed, including forming a precursor electroactive anode material via solid-state synthesis or co-precipitation and converting the precursor electroactive anode material to an electroactive material through ion-exchange. Compositions comprising electroactive anode material (e.g., H₂W₂O₇) and electrodes incorporating these materials for use in electrochemical cells are also presented.

### CROSS-REFERENCE TO RELATED APPLICATIONS

This application claims priority to and benefit of U.S. Provisional Application No. 63/729,311, filed on Dec. 6, 2024, the entire contents of which are hereby incorporated by reference.

### TECHNICAL FIELD

This disclosure relates generally to anode materials for electrochemical cells and methods of their synthesis.

### BACKGROUND

Energy storage devices, such as electrochemical cells, typically include an anode, a cathode, an electrolyte, and a separator. Despite the apparent simplicity of these components, the electrochemical environment within such devices is highly complex. This complexity can lead to performance limitations, including undesirable side reactions, electrochemical passivation, and structural degradation of electrode materials. These issues may occur at one or more electrodes, within the electrolyte, or at the electrode-electrolyte interface, ultimately reducing cycle life, energy efficiency, and safety.

In aqueous secondary batteries and other advanced energy storage systems, the choice of electrode composition plays a critical role in mitigating these challenges. Conventional synthesis methods for electrode materials, such as co-precipitation, often involve lengthy processing times, multiple steps, and high energy consumption. These processes can also produce materials with suboptimal particle size distribution, surface area, and phase purity, which negatively impact electrochemical kinetics and stability.

Accordingly, there is a need for improved electrode compositions and synthesis methods that: reduce processing time and energy consumption, provide high phase purity and controlled morphology, enhance electrochemical stability and kinetics, and are suitable for integration into aqueous or other battery chemistries.

### SUMMARY

Presented herein are methods of manufacturing an electroactive anode material for use in energy storage applications, which comprise various embodiments disclosed herein. For example, disclosed embodiments may provide for, inter alia, the formation of precursor tungsten oxide materials through solid-state synthesis or co-precipitation, conversion of these precursors into electroactive materials via ion-exchange processes, and production of compositions comprising H₂W₂O₇ suitable for use in electrodes. Certain embodiments may also provide for controlled particle size distributions, recovery of an oxide precursor (e.g., a bismuth precursor) (e.g., BiOCl) from a post-ion-exchange waste stream for use in a new electroactive anode material manufacturing process, and integration of computing systems for process control. The present disclosure addresses the aforementioned needs by providing, inter alia, a precursor formation, for example by solid state synthesis or by co-precipitation, and subsequent ion-exchange process to produce bismuth-tungsten oxide-based materials with superior structural and electrochemical properties compared to conventional methods.

In some embodiments, the present disclosure is directed toward a method of manufacturing an electroactive anode material (e.g., of manufacturing an anode). The method may comprise forming a precursor electroactive anode material comprising a first tungsten oxide material (e.g., in an aqueous slurry) (e.g., a metal tungsten oxide material) and performing an ion-exchange process on the precursor electroactive anode material to obtain an electroactive anode material comprising a second tungsten oxide material. In some embodiments, the solid-state synthesis is performed using BiOCl, Bi(NO₃)₃, Bi₂(SO₄)₃, BiO(NO₃), Bi₂O₃, Bi₂S₃, BiX₃ (where X is a halide), or bismuth subsalicylate and a precursor for tungsten to obtain the first tungsten oxide, wherein the first tungsten oxide is a bismuth tungsten oxide (BTO). In some embodiments, the first tungsten oxide material is a metal tungsten oxide (e.g., a bismuth tungsten oxide (BTO)).

In some embodiments, forming the precursor electroactive anode material comprises performing a solid-state synthesis. In some embodiments, the solid-state synthesis comprises reacting a first precursor (e.g., for an oxide) and a second precursor (e.g., for tungsten) together to form a mixture comprising the precursor electroactive anode material. In some embodiments, the first precursor is Bi₂O₃ and the second precursor is WO₃. In some embodiments, Bi₂O₃ acts as both a reactant and a solvent in the solid-state synthesis. In some embodiments, the solid-state synthesis is a molten solid-state synthesis conducted at a temperature in a range of from 700° C. to 900° C. (e.g., 800° C. to 900° C.) over a period of time of no more than 5 hours of process time.

In some embodiments, forming the precursor electroactive anode material comprises performing a co-precipitation. In some embodiments, the co-precipitation comprises reacting a first precursor (e.g., for an oxide) and a second precursor (e.g., for tungsten) together to form a mixture comprising the precursor electroactive anode material. In some embodiments, the reacting happens at a pH in a range of from 5 to 6. In some embodiments, the co-precipitation comprises neutralizing the mixture with a base (e.g., ammonium hydroxide) to form a stable mixture. In some embodiments, the co-precipitation further comprises drying the stable mixture (e.g., by spray drying) to form a dried mixture comprising the precursor electroactive anode material. In some embodiments, the co-precipitation further comprises calcining the dried mixture (e.g., at a temperature in a range of from 700° C. to 850° C.) to obtain the precursor electroactive anode material in a crystalline form. In some embodiments, the calcination comprises static calcination or rotary calcination. In some embodiments, the crystalline precursor electroactive anode material comprises flat plate-shaped particles.

In some embodiments, the second precursor (e.g., for tungsten) comprises ammonium paratungstate, calcium tungstate, sodium tungstate, potassium tungstate, scheelite, wolframite, or a combination thereof. In some embodiments, the second precursor (e.g., for tungsten) comprises ammonium metatungstate, an oxide of tungsten (e.g., WOₙ where n≤3), or a combination thereof. In some embodiments, the first precursor (e.g., for an oxide) comprises a metal nitrate, a phosphate, a sulphate, an oxide of lithium, sodium, potassium, calcium, zinc, aluminum, bismuth, molybdenum, cesium, rubidium, titanium, vanadium, chromium, manganese, iron, cobalt, nickel, copper, indium, tin, lead, or a combination thereof. In some embodiments, the first precursor (e.g., for an oxide) is Bi₂O₃ and the second precursor (e.g., for tungsten) is WO₃. In certain embodiments, the first precursor (e.g., for an oxide) is a bismuth nitrate and the second precursor (e.g., for tungsten) is ammonium paratungstate.

In some embodiments, the ion-exchange process comprises subjecting the precursor electroactive anode material to ion exchange using a strong acid (e.g., hydrochloric acid (HCl)) to form solid particles of the electroactive anode material. In some embodiments, the HCl has a concentration in a range of from 1 molar to 15 molar. In some embodiments, the ion-exchange process further comprises drying the solid particles at a temperature in a range of from 50° C. to 150° C. In some embodiments, the ion-exchange process further comprises sieving the dried particles. In some embodiments, the solid particles after sieving have a particle size distribution characterized by a D50 in a range of from 170 μm to 210 μm. In some embodiments, the ion-exchange process comprises three sequential ion-exchange steps. In certain embodiments, each of the ion-exchange steps is performed at a temperature in a range of from 40° C. to 60° C.

In some embodiments, the second tungsten oxide material comprises H₂W₂O₇ (LT). In some embodiments, the electroactive anode material comprises particles comprising the second tungsten oxide material and having a particle size distribution characterized by a D50 in a range of from 10 μm to 30 μm.

In some embodiments, the method comprises forming an electrode comprising the electroactive anode material and one or more conductive additives and/or one or more binders (e.g., polymer binders). In some embodiments, the method further comprises disposing (e.g., depositing) the electrode on an electrically conducting current collector.

The first tungsten oxide material may be a bismuth tungsten oxide (BTO). The bismuth source for the bismuth tungsten oxide may be Bi(NO₃)₃, Bi₂(SO₄)₃, BiO(NO₃), Bi₂O₃, Bi₂S₃, BiX₃ (where X is a halide), bismuth subsalicylate, Bi₂O₂(CO₃), Bi(CH₃COO)₃, or BiOCl. The tungsten source for the bismuth tungsten oxide may be ammonium paratungstate, ammonium metatungstate, ammonium tungstate, sodium tungstate, potassium tungstate, tungsten phosphate and/or WOₙ (where n≤3).

In some embodiments, the method further comprises recovering a precursor (e.g., for an oxide) (e.g., a bismuth precursor) (e.g., BiOCl) from a post-ion-exchange waste stream. In some embodiments, the method comprises forming the precursor electroactive material from a recycled precursor (e.g., for an oxide) (e.g., a bismuth precursor) (e.g., BiOCl), e.g., recycled from a post-ion-exchange waste stream. In some embodiments, the recovered precursor can be recycled for use in a new electroactive anode material manufacturing process. In some embodiments, forming the precursor electroactive active material is performed using a first precursor (e.g., for an oxide) and a second precursor (e.g., for tungsten) and the first precursor is a bismuth oxide or bismuth oxychloride. In some embodiments, the first precursor is bismuth oxychloride. In some embodiments, the first precursor is a recycled material (e.g., recycled from a waste stream of an ion-exchange process). In some embodiments, the method comprises recovering the bismuth oxide or bismuth oxychloride from a waste stream of an ion-exchange process (e.g., wherein the bismuth oxide or bismuth oxychloride is a byproduct of the ion-exchange process). In some embodiments, the ion-exchange process is a continuous process comprising an inline filter.

In some aspects, the present disclosure is directed to a composition produced by the method described herein. In some embodiments, the composition comprises the electroactive anode material comprising H₂W₂O₇. In some embodiments, the composition is in the form of a powder. In some embodiments, the composition is combined with one or more conductive additives, polymeric binders, and an electrically conductive current collector to form an electrode. In some embodiments, the electrode is assembled into a cell configured for use in energy storage applications. In some embodiments, the H₂W₂O₇ is configured for use as an anode material in an energy storage device.

In some aspects, the present disclosure is directed to a method of manufacturing an electroactive anode material (e.g., of manufacturing an anode), the method comprising: forming a precursor electroactive anode material comprising a first tungsten oxide material (e.g., in an aqueous slurry) (e.g., a metal tungsten oxide material) using one or more recycled precursor materials; and performing an ion-exchange process on the precursor electroactive anode material to obtain an electroactive anode material comprising a second tungsten oxide material. In some embodiments, the one or more recycled precursor materials comprises a metal oxychloride (e.g., bismuth oxychloride). In some embodiments, forming the precursor electroactive anode material is performed using one or more non-recycled precursor materials (e.g., a precursor for tungsten, e.g., ammonium paratungstate). In some embodiments, the first tungsten oxide material is bismuth tungsten oxide. In some embodiments, the second tungsten oxide material is H₂W₂O₇ (LT). In some embodiments, the method comprises obtaining the one or more recycled precursor materials from a waste stream of an ion-exchange process (e.g., as byproducts of the ion-exchange process). In some embodiments, the method comprises obtaining one or more recycled precursor materials from a waste stream of the ion-exchange process. In some embodiments, the method comprises forming a second precursor electroactive anode material using the one or more recycled precursor materials. In some embodiments, the method comprises iteratively performing the forming and performing steps using byproduct material obtained from a waste stream of the ion-exchange process in one iteration of the performing step as at least one of the one or more recycled precursor materials in a subsequent iteration of the forming step.

Any two or more of the features described in this specification, including in this summary section, may be combined to form implementations not specifically explicitly described in this specification.

### BRIEF DESCRIPTION OF THE DRAWING

Drawings are presented herein for illustration purposes, not for limitation. The foregoing and other objects, aspects, features, and advantages of the disclosure will become more apparent and may be better understood by referring to the following description taken in conjunction with the accompanying drawings, in which:

FIG. 1 shows a simplified process flow diagram describing anode synthesis, according to illustrative embodiments of the present disclosure;

FIG. 2 shows an elaborated process flow diagram for the first step in anode synthesis. The reaction rates, temperature of the reactions, or the drying and calcination processes are not bound by the ranges described in the schematic, according to illustrative embodiments of the present disclosure;

FIG. 3 shows an SEM of powder morphology before calcination (LEFT) and after calcination (RIGHT), according to illustrative embodiments of the present disclosure;

FIG. 4 shows XRD profiles of the powder before and after calcination, according to illustrative embodiments of the present disclosure;

FIG. 5 shows a process lay out of the second step in anode synthesis, according to illustrative embodiments of the present disclosure;

FIG. 6 shows particle size distribution of the anode powder, according to illustrative embodiments of the present disclosure;

FIG. 7 shows XRD patterns of the precursor produced via solid-state synthesis (SSS) and co-precipitation reactions, according to illustrative embodiments of the present disclosure;

FIG. 8 shows SEM images of the precursor powder produced via solid-state synthesis (LEFT) and co-precipitation (RIGHT) reactions, according to illustrative embodiments of the present disclosure;

FIG. 9 shows SEM images of the precursor powder produced via solid-state synthesis, according to illustrative embodiments of the present disclosure;

FIG. 10 shows XRD patterns of H₂W₂O₇ produced from solid-state synthesis Bi₂W₂O₇ produced versus H₂W₂O₇ produced from standard production method, according to illustrative embodiments of the present disclosure;

FIG. 11 shows XRD patterns of H₂W₂O₇ produced from milled solid-state synthesis Bi₂W₂O₇ produced versus H₂W₂O₇ produced from standard production method and WO₃, according to illustrative embodiments of the present disclosure; and

FIG. 12 shows a representative XRD spectrum of LT material synthesized as described in Example #3, according to illustrative embodiments of the present disclosure;

### DETAILED DESCRIPTION OF CERTAIN EMBODIMENTS

The following description provides illustrative embodiments of methods and compositions disclosed herein. It should be understood that the embodiments described are not intended to limit the scope of the claims, but rather to provide examples of how the claimed subject matter may be implemented.

### Overview of Anode Synthesis

In some embodiments, the present disclosure relates to methods of manufacturing an electroactive anode material comprising tungsten oxide for use in energy storage devices. The method generally includes two primary steps: (i) forming a precursor electroactive anode material comprising a first tungsten oxide material (e.g., Bi₂W₂O₉) and (ii) performing an ion-exchange process on the precursor to obtain an electroactive anode material comprising a second tungsten oxide material (e.g., H₂W₂O₇). A first tungsten oxide material may be a bismuth tungsten oxide (BTO). A bismuth source for a bismuth tungsten oxide may be Bi(NO₃)₃, Bi₂(SO₄)₃, BiO(NO₃), Bi₂O₃, Bi₂S₃, BiX₃ (where X is a halide), bismuth subsalicylate, Bi₂O₂(CO₃), Bi(CH₃COO)₃, or BiOCl. A tungsten source for a bismuth tungsten oxide may be ammonium paratungstate, ammonium metatungstate, ammonium tungstate, sodium tungstate, potassium tungstate, tungsten phosphate and/or WOₙ (where n≤3).

In certain embodiments, the electroactive anode material comprises a tungsten oxide structure synthesized through a multi-step process. The process generally includes (i) formation of a solid precursor material via co-precipitation or solid-state synthesis and (ii) conversion of the precursor into a final tungsten oxide anode material through an ion-exchange reaction. Each process may include an acidic synthesis step, removal of the acid, and drying of the resulting solids.

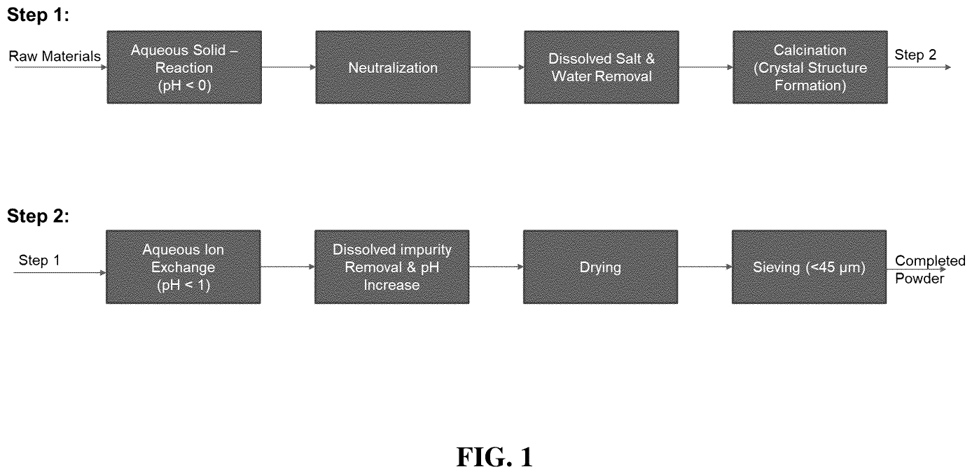

A simplified process flow diagram for the two-step synthesis is shown in FIG. 1. In some embodiments, water removal in step 1 may be adjusted if calcination achieves target drying specifications.

In some embodiments, an anode (e.g., of an electrochemical cell, e.g., energy storage device, e.g., a battery, e.g., a secondary battery) comprises an electroactive anode material. In some embodiments, an anode (e.g., of an electrochemical cell, e.g., energy storage device, e.g., a battery, e.g., a secondary battery) comprises an anode material comprising an electroactive anode material. An electroactive anode material may comprise a tungsten oxide.

An electroactive anode material may be a particulate material. An electroactive anode material may be a powder (e.g., of particles) (e.g., before being assembled into an anode). An electroactive anode material may comprise particles. An anode material may be a particulate material. An anode material may be a powder (e.g., of particles) (e.g., before being assembled into an anode). An anode material may comprise particles.

In certain embodiments, the synthesis of Layered Tungsten Oxide (H₂W₂O₇, LT) is a three-step process beginning with the synthesis of precursor electroactive anode material (e.g., Bismuth Tungsten Oxide (Bi₂W₂O₉, BTO)), calcination of the precursor electroactive anode material (e.g., BTO) and finally, an ion exchange process to generate the electroactive anode material (e.g., LT final product).

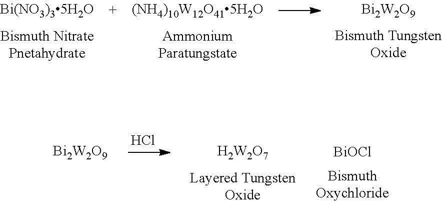

### General Process Details

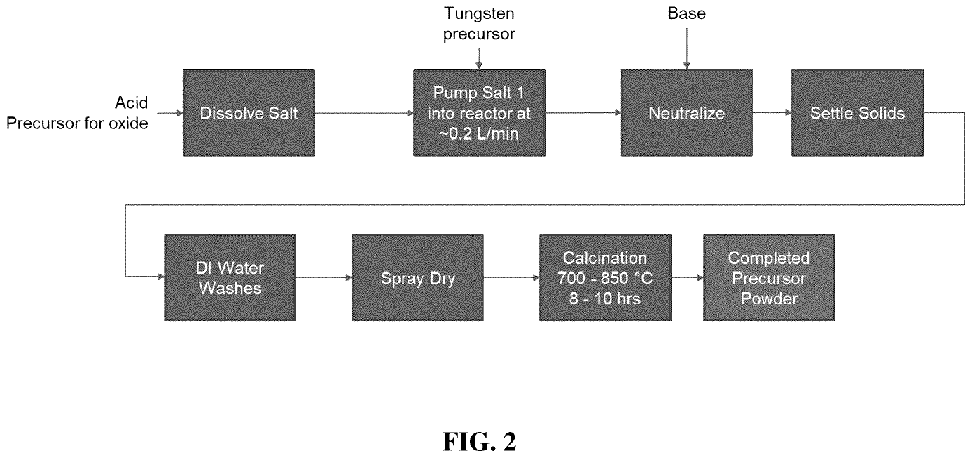

Broadly, the synthesis involves reacting a first precursor (e.g., for an oxide) with a second precursor (e.g., for tungsten). Suitable oxide precursors include, but are not limited to, metal nitrates, phosphates, sulfates, and oxides of metals such as lithium, sodium, potassium, calcium, zinc, aluminum, bismuth, molybdenum, cesium, rubidium, titanium, vanadium, chromium, manganese, iron, cobalt, nickel, copper, indium, tin, and lead. Suitable tungsten precursors include ammonium paratungstate, calcium tungstate, sodium tungstate, potassium tungstate, scheelite, wolframite, and other tungstate forms. An elaborated process flow for step 1 is shown in FIG. 2. Reaction rates, temperatures, and drying or calcination conditions are not limited to the ranges depicted in the schematic.

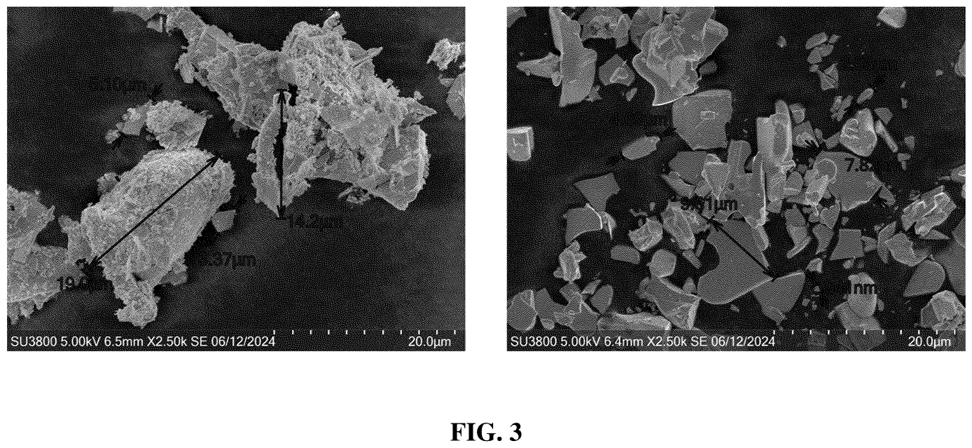

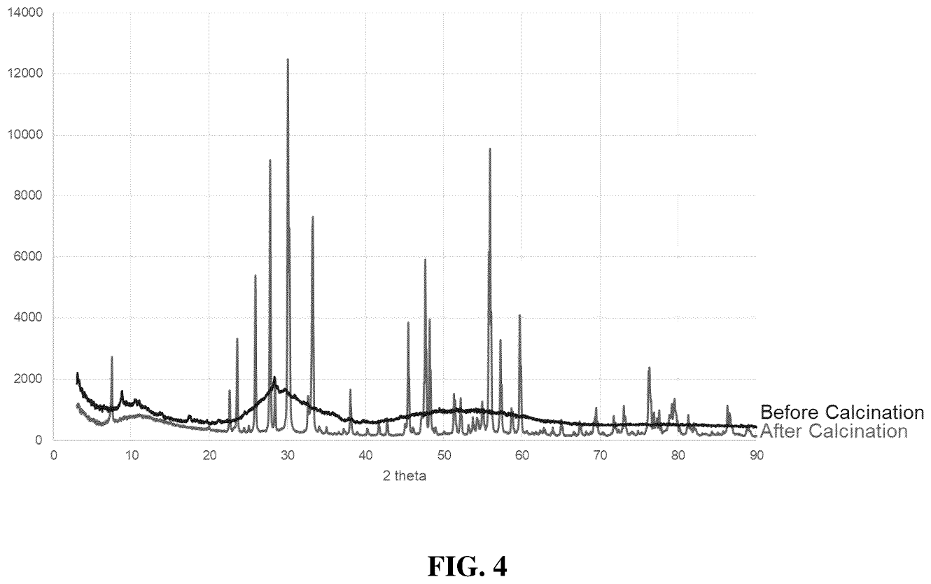

FIG. 3 illustrates scanning electron microscopy (SEM) images of powder morphology before and after calcination. A calcination step may control (e.g., improve) crystallinity, as shown in the X-ray diffraction (XRD) profiles in FIG. 4.

In some embodiments, a spray drying process may be used to produce an anode material comprising an electroactive anode material. In some embodiments, a spray drying process may be used to produce an electroactive anode material. Other drying processes may be used.

In some embodiments, calcination conditions such as temperature, time, and environment may be controlled to influence particle attributes (e.g., size and/or morphology) of an anode material comprising an electroactive anode material. In some embodiments, calcination may include static calcination or rotary calcination.

In some embodiments, addition rate of one or more oxide precursors, addition rate of tungsten precursor, concentration of one or more acids, concentration of one or more oxide precursors, concentration of one or more tungsten precursors, temperature, dwell time, environment, or a combination thereof may be adjusted to achieve one or more certain desirable attributes such as, for example, particle size and/or morphology, throughput, yield, purity, or a combination thereof.

### Formation of Precursor Electroactive Material

### Solid-State Synthesis

In some embodiments, the precursor material is formed by solid-state synthesis. The solid-state synthesis may comprise reacting a first precursor (e.g., for an oxide) and a second precursor (e.g., for tungsten) together to form a mixture comprising the precursor electroactive anode material. Suitable oxide precursors include Bi₂O₃, BiOCl, Bi(NO₃)₃, Bi₂(SO₄)₃, Bi₂S₃, BiX₃ (where X is a halide), or bismuth subsalicylate. Suitable tungsten precursors include WO₃, ammonium paratungstate, ammonium metatungstate, tungstate salts, scheelite, wolframite, or tungsten oxides (e.g., WOₙ where n≤3).

In some embodiments, the solid-state synthesis is a molten process conducted at a temperature in a range of from about 700° C. to about 900° C. (e.g., 800° C. to 900° C.) for no more than 5 hours. In certain embodiments, Bi₂O₃ acts as both a reactant and a solvent during the molten synthesis.

### Co-Precipitation

In some embodiments, the precursor electroactive anode material is formed by co-precipitation. The co-precipitation process may include reacting oxide and tungsten precursors in solution, adjusting pH, neutralizing with a base (e.g., ammonium hydroxide), and forming a stable mixture. The mixture may then be dried (e.g., spray drying) and calcined at a temperature in a range of from about 700° C. to about 850° C. to obtain a crystalline precursor material. In some embodiments, the crystalline precursor comprises flat plate-shaped particles.

An electroactive anode material may be synthesized using a co-precipitation (e.g., through a co-precipitation). In some embodiments, a co-precipitation produces solid precursor particles. A method of manufacturing an electroactive anode material may include an ion exchange reaction performed on solid precursor particles obtained from a co-precipitation, for example to obtain an electroactive anode material (e.g., a tungsten oxide). In some embodiments, a method of manufacturing an electroactive anode material includes an acidic synthesis reaction (e.g., as a co-precipitation) followed by removal of acid and drying.

### Ion-Exchange Process

In some embodiments, the precursor electroactive anode material undergoes ion exchange using a strong acid, such as hydrochloric acid (HCl), at a concentration in a range of from about 1 molar to about 15 molar. The ion-exchange process may include multiple sequential steps (e.g., three steps), each performed at a temperature in a range of from about 40° C. to about 60° C. After ion exchange, the material may be dried at a temperature in a range of from about 50° C. to about 150° C. and sieved to achieve a particle size distribution characterized by a D50 in a range of from about 10 μm to about 30 μm. The product of step 1 is a metal tungsten oxide powder serving as the precursor for step 2. This metal tungsten oxide powder may include one or more metals such as, for example, lithium, sodium, potassium, calcium, zinc, aluminum, bismuth, molybdenum, cesium, rubidium, titanium, vanadium, chromium, manganese, iron, cobalt, nickel, copper, indium, tin, and lead, or a combination thereof.

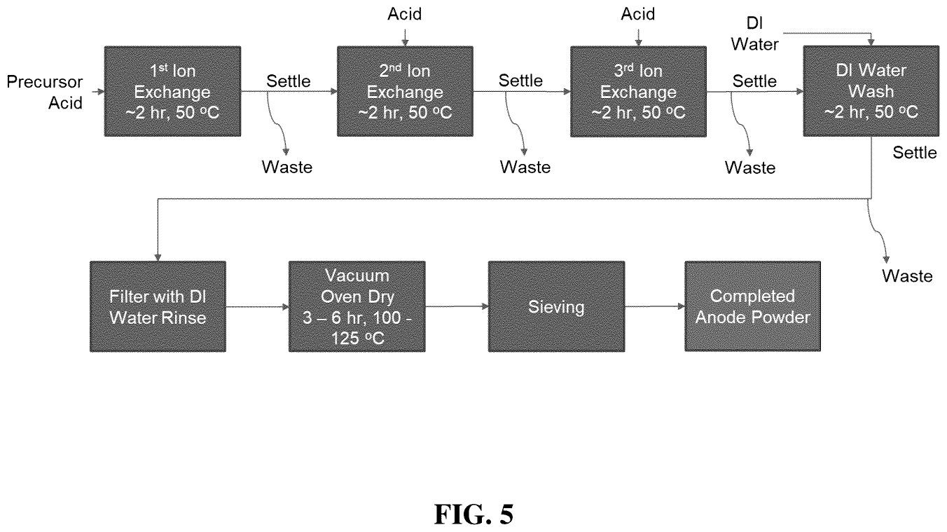

FIG. 5 illustrates a process layout for the ion-exchange step, the second step in anode synthesis. An ion-exchange process may be utilized to exchange a metal from an oxide precursor with a substitute. Depending on the substitute, the exchange can be facilitated by an acid, a base, or other reaction medium. Temperature, concentration of exchange initiator (e.g., acid), number of ion exchanges, and residence time may be adjusted, for example to achieve one or more desirable targets such as, for example, particle size and/or morphology, throughput, yield, purity, or a combination thereof.

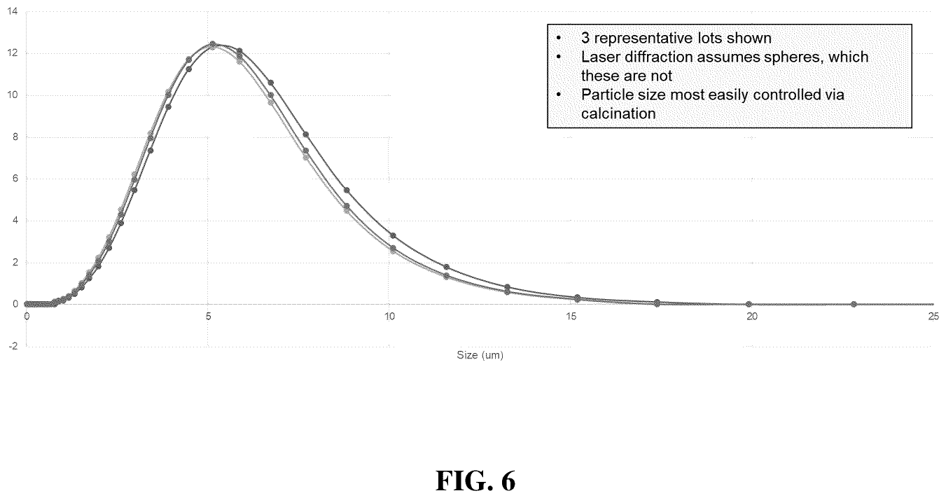

FIG. 6 shows a representative particle size distribution of the final anode powder.

### Electrode Formation and Composition

In some embodiments, the electroactive anode material comprises H₂W₂O₇ and is combined with one or more conductive additives and one or more polymeric binders to form an electrode. The electrode may be disposed on an electrically conductive current collector and assembled into a cell configured for use in energy storage applications.

### Additional Features

In some embodiments, a post-ion-exchange waste stream can be processed to recover (i) metal from an oxide precursor and/or (ii) an oxide precursor itself. In certain embodiments, the oxide precursor is a bismuth precursor (e.g., BiOCl). Such recovered metal and/or oxide precursor may be recycled for use in a new anode material manufacturing process (e.g., in step 1 of an anode synthesis process as discussed above). Such recycling may significantly reduce volume usage of precursor and drastically cut down on a bill of materials.

In some embodiments, bismuth tungsten oxide (BTO) subsequently used, e.g., to produce LT, may be made using BiOCl, which serves as the bismuth precursor for the BTO. BTO, whether produced using recycled BiOCl or another bismuth precursor, can be further processed to produce LT through ion exchange. For example, in some embodiments, an ion-exchange process involves dissolving BTO in a 6 M HCl solution and heating the mixture to 50° C. for 90 minutes. After the heating period, the mixture is allowed to settle, and the supernatant is decanted. This process may be repeated, for example, two more times to ensure thorough ion exchange. Finally, the material may be washed with water and filtered to obtain a final product of H₂W₂O₇(LT). The BTO produced through this process may be chemically similar to traditional BTO produced from Bi(NO₃)₃, but using BiOCl as a precursor.

A process of obtaining BTO or LT therefrom may begin by obtaining BiOCl, either as a waste byproduct from the anode material production. For example, when BTO is dissolved in an acidic (e.g., 6 M HCl) solution as part of forming LT, the acidic environment may lead to the formation of BiOCl as a byproduct. This can happen because, under some such conditions, bismuth ions (Bi³⁺) from BTO may react with chloride ions (Cl⁻) from HCl. The combination of Bi³⁺ and Cl⁻ forms BiOCl, a compound that precipitates from the solution as an insoluble material, for example while a W (tungsten) species remain in solution. In some embodiments, for example where the synthesis is a co-precipitation reaction, BiOCl may be dissolved in nitric acid until the solution becomes clear. Afterward, a tungsten source such as ammonium paratungstate (APT), may be added to this solution, leading to the precipitation of BTO. Once BTO is formed, it may be put through a calcination process to stabilize structure. BTO may then be ion-exchanged to form an anode material, for example LT. In some embodiments, BiOCl and a tungsten source are combined in a crucible and heated in a furnace to induce BTO synthesis via a solid-state reaction. BTO may then be then converted to LT for example via an ion-exchange process. In a solid-state synthesis, BiO₃ may form detrimentally but can be converted to BiCl₃ then BiOCl and then used as recycling stream for further BTO formation.

BTO formation may include dissolution of BiOCl in an acid, for example nitric acid, in the presence of a tungsten source, for example APT. A calcination step may be used to ensure a proper phase transition. An ion exchange step may be used to adjust chemical composition to create LT. BiOCl used as a precursor in BTO synthesis can be sourced from a waste stream, reducing costs and increasing sustainability in the production process. BiOCl may be virgin or reclaimed from a waste stream of an anode production process. A process for making BTO may include using both virgin and recycled BiOCl. BTO produced using reclaimed/recycled BiOCl can be used directly for various applications. BTO produced using reclaimed/recycled BiOCl can be further processed to form LT through ion exchange.

By utilizing BiOCl from a waste stream, a process may reduce the need to purchase additional raw materials, leading to cost savings. A process for making BTO may include using both virgin and recycled BiOCUp to Recycling BiOCl from waste not only reduces material costs but also minimizes environmental impact by reducing waste generation. A process that utilizes recycled BiOCl provides a more streamlined and cost-effective method for producing BTO and LT, without sacrificing quality or performance of a final anode material. A process that utilizes recycled BiOCl may allow for use of various Bi and W sources, offering versatility in material selection. LT made using recycled precursor has demonstrated an XRD pattern with similar peaks as an LT standard made without recycled precursor.

In some embodiments, an ion exchange process can be a continuous process integrated with an inline filter or other such inline separation process, which may further increase throughput, control and/or consistency.

In some embodiments, a precursor powder for step 2 that is obtained at the end of step 1, may also be produced via a solid-state synthesis reaction. Such a precursor powder may be a metal tungsten oxide powder, where the metal may contain one or more metals, such as, for example, lithium, sodium, potassium, calcium, zinc, aluminum, bismuth, molybdenum, cesium, rubidium, titanium, vanadium, chromium, manganese, iron, cobalt, nickel, copper, indium, tin, lead, or a combination thereof.

A solid-state synthesis may result in an increased output of anode material and/or utilize less footprint for scale-up and high-volume manufacturing. Reaction purification may be simplified compared to certain co-precipitation and ion-exchange reactions. Such a solid-state reaction may eliminate need for spray drying or other similar steps.

In some embodiments, a solid-state synthesis process for an electroactive anode material includes grinding of precursor powders, a thermal treatment, and a cooling step. Precursor powders may include a source for tungsten and/or one or more oxide sources, such as, for example, an oxide, a sulphate, a phosphate, or a nitrate. A solid-state synthesis process may include a milling step, for example to achieve a desirable particle size distribution. A solid-state synthesis process may further include purification, spray-drying, sieving, or a combination thereof (e.g., after milling or after cooling).

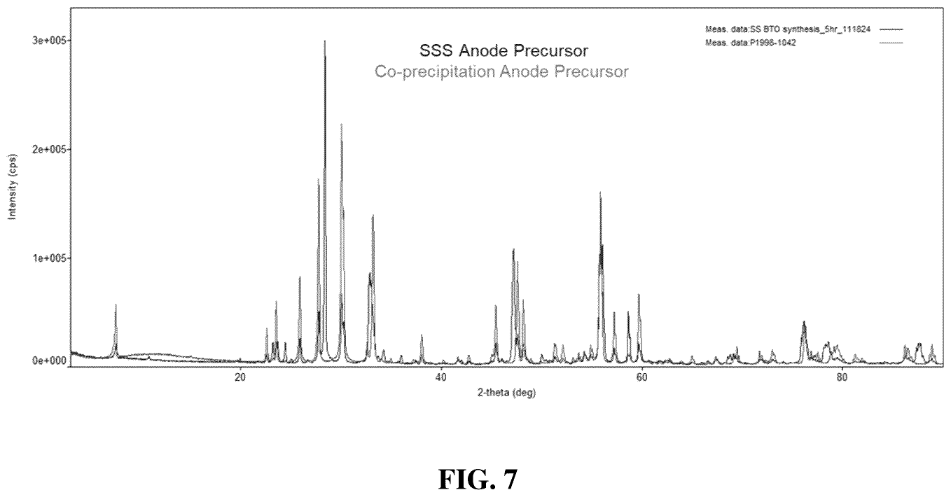

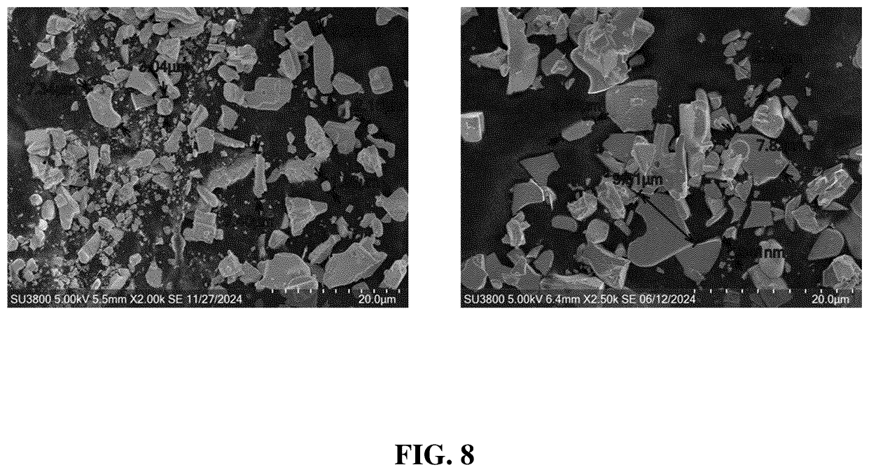

In some embodiments, the solid-state synthesis may involve grinding precursor powders, thermal treatment, and cooling, optionally followed by milling, purification, spray drying, and sieving. FIG. 7 and FIG. 8 compare XRD profiles and SEM images of precursors produced by solid-state synthesis and co-precipitation.

In some embodiments, a semi-solid or molten state reaction may be used (e.g., in a process modified from using a solid-state synthesis reaction). Reaction temperature of such a reaction may cause an oxide precursor such as an oxide, sulphate, phosphate, or nitrate of a metal (for example including lithium, sodium, potassium, calcium, zinc, aluminum, bismuth, molybdenum, cesium, rubidium, titanium, vanadium, chromium, manganese, iron, cobalt, nickel, copper, indium, tin, lead or a combination thereof) to melt. Such a semi-solid or molten synthesis could further reduce reaction times. Such a semi-solid or molten synthesis may help achieve one or more desirable properties including, but not limited to, with respect to crystallinity, purity, yield, particle size, particle morphology, or a combination thereof.

At least part of the methods, systems, and techniques described in this specification may be controlled by executing, on one or more processing devices, instructions that are stored on one or more non-transitory machine-readable storage media. Examples of nontransitory machine-readable storage media include read-only memory, an optical disk drive, memory disk drive, and random access memory. At least part of the methods, systems, and techniques described in this specification may be controlled using a computing system including one or more processing devices and memory storing instructions that are executable by the one or more processing devices to perform various control operations.

It is contemplated that systems, devices, methods, and processes of the disclosure encompass variations and adaptations developed using information from the embodiments described herein. Adaptation and/or modification of the systems, devices, methods, and processes described herein may be performed by those of ordinary skill in the relevant art.

Throughout the description, where articles, devices, and systems are described as having, including, or comprising specific components, or where processes and methods are described as having, including, or comprising specific steps, it is contemplated that, additionally, there are articles, devices, and systems according to certain embodiments of the present disclosure that consist essentially of, or consist of, the recited components, and that there are processes and methods according to certain embodiments of the present disclosure that consist essentially of, or consist of, the recited processing steps.

It should be understood that the order of steps or order for performing certain action is immaterial so long as operability is not lost. Moreover, two or more steps or actions may be conducted simultaneously. As is understood by those skilled in the art, the terms “over”, “under”, “above”, “below”, “beneath”, and “on” are relative terms and can be interchanged in reference to different orientations of the layers, elements, and substrates included in the present disclosure. For example, a first layer on a second layer, in some embodiments means a first layer directly on and in contact with a second layer. In other embodiments, a first layer on a second layer can include another layer there between.

Headers are provided for the convenience of the reader and are not intended to be limiting with respect to the claimed subject matter.

In this application, unless otherwise clear from context or otherwise explicitly stated, (i) the term “a” may be understood to mean “at least one”; (ii) the term “or” may be understood to mean “and/or”; (iii) the terms “comprising” and “including” may be understood to encompass itemized components or steps whether presented by themselves or together with one or more additional components or steps; (iv) the terms “about” and “approximately” may be understood to permit standard variation as would be understood by those of ordinary skill in the relevant art; and (v) where ranges are provided, endpoints are included. In certain embodiments, the term “approximately” or “about” refers to a range of values that fall within 25%, 20%, 19%, 18%1, 7%1, 6%1, 5%1, 4%1, 13%, 12%, 1%, 10%, 9%, 8%, 7%, 6%, 5%, 4%, 3%, 2%, 1%, or less in either direction (greater than or less than) of the stated reference value unless otherwise stated or otherwise evident from the context (except where such number would exceed 100% of a possible value).

Certain embodiments of the present disclosure were described above. It is, however, expressly noted that the present disclosure is not limited to those embodiments, but rather the intention is that additions and modifications to what was expressly described in the present disclosure are also included within the scope of the disclosure. Moreover, it is to be understood that the features of the various embodiments described in the present disclosure were not mutually exclusive and can exist in various combinations and permutations, even if such combinations or permutations were not made express, without departing from the spirit and scope of the disclosure. The disclosure has been described in detail with particular reference to certain embodiments thereof, but it will be understood that variations and modifications can be effected within the spirit and scope of the claimed invention.

### EXEMPLIFICATION

The following examples embody certain methods, compositions, and electrochemical cells of the present disclosure and demonstrate fabrication of exemplary electrodes, according to certain embodiments described herein. Moreover, the following examples are included to demonstrate principles of disclosed compositions and methods and are not intended as limiting.

### Example #1—BTO Synthesis

In one exemplary embodiment, 11 liters of deionized water is introduced into a 20-liter, three-neck flask. To this, 0.6 liters of 70% nitric acid is added to form a solution containing 5 wt % nitric acid. Using a powder funnel, 1.0 kilogram of bismuth nitrate pentahydrate is added to the solution. The mixture is stirred at 250 rpm until complete dissolution is achieved. The resulting bismuth nitrate solution is then transferred to an empty 20-liter container. Separately, 2.75 liters of deionized water and 554 grams of ammonium paratungstate are added to the empty 20-liter flask and stirred at 250 rpm to form a slurry.

The bismuth nitrate solution is added to the slurry via a peristaltic pump over a period of six hours at a calculated rate of 32.22 mL/min. Upon completion of the addition, the resulting white slurry is stirred for an additional 30 to 60 minutes.

A pH meter is inserted into the stirring slurry. Using an addition funnel, between 900 and 1000 mL of 28-30% ammonium hydroxide solution is added to adjust the pH to a range of 5 to 6. The slurry is stirred for an additional 20 minutes, and the pH is checked. Additional ammonium hydroxide may be added as needed to achieve the desired pH.

Stirring is then discontinued, and the solids are allowed to settle. While settling may occur overnight due to time constraints, a period of one hour is generally sufficient. The supernatant is removed via peristaltic pump and directed to waste.

Stirring is resumed, and the solids are suction filtered using two large Buchner funnels equipped with Whatman ashless filter paper and a 20-liter filter flask. During filtration, the solids are continuously packed down to eliminate cracks in the filter cake. The filter cake is maintained under vacuum for one hour.

The filter cakes are transferred to two Pyrex dishes and dried in a convection oven at 120° C. At intervals of one to two hours, the solids are broken up until a powder is formed. The resulting powder is then sieved through a 2 mm stainless steel sieve.

### Example #2—Calcination

The BTO powder obtained from Example #1 is evenly distributed onto a quartz tray. The tray is inserted into a box furnace. The powder is heated to 823° C. for a period of eight hours, with a temperature ramp from room temperature at a rate of 5° C. per minute. After cooling to ambient temperature, the resulting off-yellow crystalline solids are re-sieved. The weight of the material is recorded, and characterization may be performed using X-ray diffraction (XRD) and particle size analysis.

### Example #3—Synthesis of LT (Ion Exchange)

A first ion-exchange step is performed by introducing 3 liters of 6 M hydrochloric acid (HCl) into a 5-liter jacketed pressure reactor. The mechanical stirrer is set to 400 rpm. Using a powder funnel, the BTO powder obtained from Example #2 is carefully transferred into the reactor. All ports of the reactor are sealed, and the heating process is initiated using a temperature control system (e.g., Huber Ministat chiller) to ramp the temperature to 50° C., hold for one hour, and then cool to 25° C.

As cooling begins, stirring is discontinued, and the yellow solids are allowed to settle for one hour. The supernatant is decanted and directed to waste.

A second ion-exchange step is performed by adding an additional 3 liters of 6 M HCl and repeating the heating cycle described above.

A third ion-exchange step is performed by repeating the procedure described for the second ion-exchange step.

In certain embodiments, the number of ion-exchange steps may be reduced by increasing the concentration of HCl. For example, when using 9 M HCl, two ion-exchange steps followed by a 3 M HCl wash may yield acceptable results. When using 12 M HCl, a single ion-exchange step followed by two 3 M HCl washes may yield acceptable results.

Following the final ion-exchange step, the supernatant is decanted, and 500 mL of deionized water is added to the reactor. The slurry is stirred at 200 rpm for at least 10 minutes.

The solids are then filtered using two large Buchner funnels equipped with Whatman ashless filter paper and a 5-liter filter flask. The reactor and filtered solids are rinsed several times with deionized water. The filter cake is maintained under vacuum for at least one hour. The filter cakes are transferred to two Pyrex dishes and dried in a vacuum oven at 105° C. for four hours.

For suitability in slot-die coating applications, the dried powder may be sieved below a 325-mesh screen to remove oversized particles. A vibratory sieve equipped with ultrasonic deblinding may be used.

Quality control (QC) testing may include X-ray fluorescence (XRF), X-ray diffraction (XRD), and particle size analysis. XRF testing may determine bismuth, tungsten, and chlorine content, with weight percentages calculated based on the mass of these three elements. In certain embodiments, bismuth content ranges from 0.8 wt % to 2.1 wt %, chlorine content ranges from 0.4 wt % to 0.9 wt %, and tungsten content ranges from 97.0 wt % to 98.8 wt %.

Particle size may be measured by laser diffraction. In certain embodiments, the D10 (10th percentile) of the particle size distribution ranges from 1.9 μm to 2.0 μm, the D50 ranges from 4.0 μm to 5.6 μm, and the D90 ranges from 7.0 μm to 9.6 μm.

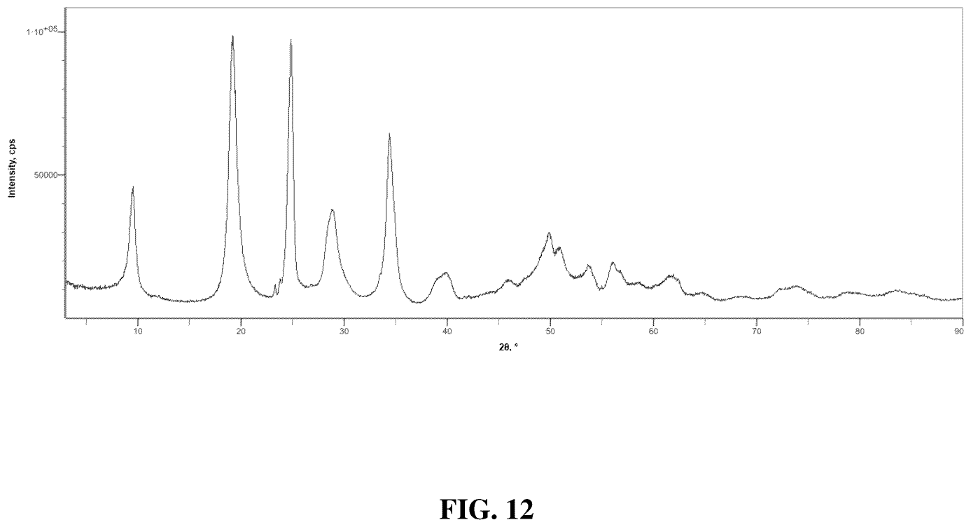

A representative XRD spectrum is shown FIG. 12.

### Example #4—Effects of the Addition Rate of Bismuth Nitrate Pentahydrate on BTO Synthesis

In certain embodiments, the effect of the addition rate of bismuth nitrate pentahydrate on BTO synthesis was evaluated. Addition rates were based on milliliters per minute (mL/min). However, the peristaltic pump was not calibrated, and tubing dimensions may have changed over time; therefore, the rate setting and actual rate were close but not exact.

Initially, based on small-scale literature methods, the development of the BTO process involved bismuth nitrate addition rates between 25 mL/min and 40 mL/min. At this rate, scaling to a 20-liter flask resulted in total addition times exceeding six hours, consuming most of the workday. After completion of the addition, the reaction mixture was neutralized, stirring was stopped, and the mixture was allowed to settle overnight. Filtration, drying, and calcination were performed the following day. Final yield of calcined BTO consistently exceeded 99%, indicating that the reaction was complete within the six-hour timeframe.

To increase productivity and reactor turnover, addition rates up to 100 mL/min were explored. This approach allowed neutralization and filtration on the same day, enabling reactor cleaning and preparation for subsequent batches the following day.

Four initial experiments were conducted at an addition rate of 100 mL/min.

In Experiment 1, the addition rate was set to 100 mL/min, and the reaction was completed in three hours. The mixture was stirred for an additional hour before neutralization and filtration. The BTO was dried overnight at 120° C. Filtration was noted to be significantly slower than normal.

Experiments 2 and 3 followed the same procedure as Experiment 1.

Experiment 4 also used an addition rate of 100 mL/min but included overnight stirring prior to neutralization and filtration.

Table 1 summarizes BTO batch data, including addition rate, yield, XRD results, and particle size (D50), along with corresponding LT batch data.

Table 2 summarizes LT batch data.

TABLE 1
BTO Batch Data

| BTO | Addition | | BTO | BTO | LT | |
|---|---|---|---|---|---|---|
| Batch | Rate | Yield | XRD | D50 | Batch | *Notes |
| 1 | 100 | 99.67 | Match | 9.6324 | 1 | |
| 2 | 100 | 93.9 | Match | 11.2316 | 2 | |
| 3 | 100 | 98.30 | Match | 10.5633 | 3 | |
| 4 | 100 | 100.52 | Match | 10.3897 | 4 | Stirred overnight |

TABLE 2
LT Batch Data

| BTO | LT | LT % | LT | LT | LT | LT | LT |
|---|---|---|---|---|---|---|---|
| Batch | Batch | Yield | D50 | % W | % Bi | % Cl | XRD |
| 1 | 1 | 98.0 | 4.5836 | 97.321 | 1.942 | 0.737 | Match |
| 2 | 2 | 100.0 | 5.1500 | 97.48 | 1.76 | 0.76 | No Match |
| 3 | 3 | 100.4 | 4.7730 | 97.213 | 1.993 | 0.793 | No Match |
| 4 | 4 | 91.4 | 4.3785 | 97.36 | 1.881 | 0.759 | Match |

Based on these data, it was determined that reactions were not always complete upon completion of bismuth nitrate addition. XRD patterns of LT batches 2 and 3 exhibited elevated peak heights at 20=23.1 and 23.6, indicating higher tungsten trioxide (WO₃) content relative to LT. WO₃ formation occurs by decomposition of excess ammonium paratungstate during calcination, suggesting incomplete reaction and insufficient consumption of ammonium paratungstate.

To quantify excess WO₃ in LT, thermogravimetric analysis (TGA) was employed based on mass loss during LT thermal decomposition. This method confirmed elevated WO₃ content in LT lots 2 and 3, as shown in Table 3.

TABLE 3
WO₃ content in LT lots

| LT Lot | WO₃ Content (wt %) |
|---|---|
| 2 | 3.6% |
| 3 | 4.8% |
| 5 through 12 Average | 1.3% (Min: 0.6%, Max 1.9%) |

From BTO other batches, the addition rate was 100 ml/min. However, each reaction was then stirred overnight and neutralized/filtered the next day. Similarly, LT from other batches used BTO from the 100 ml/min, stir overnight process. This process generated BTO/LT that met quality standards equal to materials derived from lower addition rates.

Ultimately, the process reverted to slower addition rates (40 mL/min) to simplify workflow. No statistically significant difference in LT D50 variation was observed between the two addition rates. Due to confounding factors in calcination temperature, average LT D50 values could not be statistically compared between addition rates.

Controlled addition rate of bismuth nitrate to ammonium paratungstate was shown to be critical to achieving desired BTO and LT quality metrics. Attempts to add the entire bismuth nitrate solution directly to the ammonium paratungstate suspension failed to produce the correct BTO XRD pattern, indicating that controlled addition is necessary to favor formation of Bi₂W₂O₉ rather than Bi₂WO₆. Deviations resulted in LT XRD inconsistencies, LT D50 values outside specification (4.1-5.6 μm), and LT % Bi exceeding specification (<2.1 wt %).

Table 4 summarizes experimental conditions and quality metrics for selected BTO and LT lots, including D50, XRD patterns, and elemental composition.

TABLE 4
Experimental conditions and quality metrics for selected BTO and LT lots

| | BTO | | LT D50 | LT % Bi | LT | |
|---|---|---|---|---|---|---|
| Experimental Conditions | D50 | BTO XRD | (um) | (wt %) | XRD | Notes |
| Standard concentrations & | 16.0 | Indicates some | 6.1 | 1.8 | Partial | First peak at |
| calcination at 815 C., 8 hr | | small formation | | | match | 2θ = 8 − 10 is |
| | | of Bi₂WO₆. | | | | shifted and |
| | | | | | | broad. Small |
| | | | | | | peak at 2θ = |
| | | | | | | 13 indicates |
| | | | | | | BiOCl |
| | | | | | | contamination. |
| Standard concentrations & | 21.5 | Indicates some | 5.9 | 3.2 | Partial | Additional |
| calcination at 815 C., 8 hr | | small formation | | | match | peaks at 2θ = |
| | | of Bi₂WO₆. | | | | 16.5, 25.5, and |
| | | | | | | 30 indicate |
| | | | | | | tungstite |
| | | | | | | formation. |
| Calcination at 800 C. and 7 | N/A | Indicates some | 4.9 | 2.5 | N/A | |
| hr | | small formation | | | | |
| | | of Bi₂WO₆. | | | | |
| Standard concentrations & | 23.9 | Indicates some | 8.9 | 3.2 | Pass | |
| calcination at 823 C., 8 hr | | small formation | | | | |
| | | of Bi₂WO₆. | | | | |
| Reduced nitric acid | N/A | Indicates | N/A | N/A | N/A | BTO was dark |
| concentration (3 wt % vs | | significant | | | | green color |
| typical 5 wt %) & | | formation of | | | | indicating |
| calcination at 823 C., 8 hr | | Bi₂WO₆ and | | | | excess WO₃ |
| | | WO₃ | | | | and |
| | | | | | | incomplete |
| | | | | | | reaction. |

### Example #5—LT Particle Size Control

Particle size determination for LT material is performed using a laser diffraction method with a Horiba Particle Size Analysis Instrument. The instrument software calculates particle size based on an assumption of spherical particle geometry. However, scanning electron microscopy (SEM) analysis of BTO and LT particles confirms that the particles exhibit plate-like morphology rather than spherical geometry. Accordingly, particle size measurements obtained via laser diffraction are considered reference values for comparative purposes rather than absolute dimensions.

Despite this limitation, relative particle size measurements have been shown to correlate with electrochemical performance in battery testing. Therefore, the median particle size (D50) as measured by the instrument is used as a reference point for quality control and process optimization.

### Example #6—Calcination of BTO

Calcination of BTO powders at different temperatures and dwell times has been observed to correlate directly with the particle size of the resulting LT product. Calcination generally comprises heating the dried BTO powder in a box furnace to a selected temperature and maintaining that temperature for a designated dwell time. After calcination, the powder is cooled to ambient temperature and broken up into a powder. For accurate particle size analysis, BTO powders are sieved through a 150-micron sieve prior to measurement. The Horiba method analysis for both BTO and LT must include a sonication step.

A design of experiments (DOE) study was conducted to identify optimal combinations of calcination temperature and dwell time to achieve LT particle sizes associated with improved battery performance. The target median particle size (D50) for LT was 4.5 μm to 5.0 μm.

In certain embodiments, calcination temperatures ranged from 722° C. to 839° C., and dwell times ranged from 2 hours to 10 hours. Results are summarized in Table 5.

TABLE 5
Calcination Temperature and Dwell Time on BTO and LT Particle Size and Yield

| Set | | | Ramp | Total | | | | | |
|---|---|---|---|---|---|---|---|---|---|
| Point | Dwell | Ramp | time | Time | BTO | Yield | % | LT | LT |
| (° C.) | (hrs) | (° C./min) | (hrs) | (Hrs) | D50 | (g) | Yield | Span | D50 |
| 839 | 6 | 5.0 | 2.80 | 8.80 | 181.522 | 142.1 | 96.49% | 1.139 | 8.775 |
| 816 | 2 | 5 | 2.72 | 4.72 | 11.686 | 130.5 | 95.63% | 1.444 | 3.056 |
| 793 | 4 | 5 | 2.64 | 6.64 | 8.306 | 140.1 | 97.19% | 1.763 | 2.555 |
| 736 | 8 | 5 | 2.45 | 10.45 | 7.222 | 82.7 | 95.21% | 1.817 | 1.276 |
| 736 | 8 | 5 | 2.45 | 10.45 | 8.383 | 155.1 | 97.95% | 1.815 | 1.334 |
| 720 | 9 | 5 | 2.40 | 11.40 | 7.493 | 151.6 | 96.04% | 1.470 | 0.918 |
| 767 | 2 | 5 | 2.56 | 4.56 | 9.167 | 150.9 | 96.45% | 1.411 | 1.374 |
| 800 | 10 | 5 | 2.67 | 12.67 | ND | 515.3 | 99.13% | 1.399 | 4.012 |
| 800 | 10 | 5 | 2.67 | 12.67 | 11.120 | 516.5 | 98.36% | 1.464 | 3.152 |
| 811 | 4.65 | 5 | 2.7 | 7.35 | 9.887 | 138.2 | 91.54% | 1.544 | 3.215 |
| 722 | 6.43 | 5 | 2.41 | 8.84 | 11.546 | 130.1 | 92.35% | 1.844 | 0.934 |
| 789 | 8.25 | 5 | 2.63 | 10.88 | 8.500 | 146.7 | 95.77% | 1.735 | 2.377 |
| 744 | 10 | 5 | 2.48 | 12.48 | 7.829 | 125.4 | ND | 1.851 | 1.611 |
| 816 | 2 | 5 | 2.72 | 4.72 | 8.996 | 497.7 | 98.38% | 1.614 | 3.247 |
| 800 | 10 | 5 | 2.67 | 12.67 | 11.032 | 467.6 | 99.40% | 1.387 | 3.441 |
| 815 | 8 | 5 | 2.72 | 10.72 | 10.930 | 366 | 97.28% | 1.217 | 4.521 |

Statistical analysis of the DOE data produced a predictive model capable of estimating LT particle size based on calcination parameters. This model successfully predicted the current calcination method of 823° C. for 8 hours.

The predictive model is expressed as:

$$log [ LT D 50 ] = c 1 + c 2 * [ Temperature ] + c 3 * [ Temperature ] * [ Temperature ] + c 4 * [ Dwell Time ]$$

$$where c 1 , c 2 , c 3 , and c 4 are fitted constants .$$

Following calcination, BTO undergoes ion exchange to produce the final LT product. Particle size may vary between batches; however, production data indicate an average LT particle size of 4.5 μm, with a range of 3.4 m to 5.5 μm.

No significant correlation has been observed between particle size and variations in raw material lots or vendors.

Additionally, changes in LT ion-exchange process parameters, such as solution molarity, reaction time, or reaction temperature, do not appear to significantly affect LT particle size.

### Example #7—BTO to LT Via Ion-Exchange

In one exemplary embodiment, when bismuth tungsten oxide (BTO) is processed further through an ion-exchange reaction, the material transforms into a final anode material comprising layered tungsten oxide (H₂W₂O₇, LT). The LT material exists in powder form and exhibits larger particle sizes compared to the precursor BTO, along with enhanced crystallographic features.

X-ray diffraction (XRD) analysis of LT derived from solid-state BTO reveals enhanced WO₃ peaks at 20 values of 23.1209°, 23.624°, and additional reflections at higher angles including 44.15°, 45.68°, 47.264°, 48.387°, 49.858°, 50.144°, 52.59°, 53.680°, 55.974°, and 58.36°. Furthermore, two new reflections are observed at 20 values of 16.4750 and 25.617°. These enhanced peaks and new reflections indicate structural transformation and crystallographic changes occurring during the ion-exchange process.

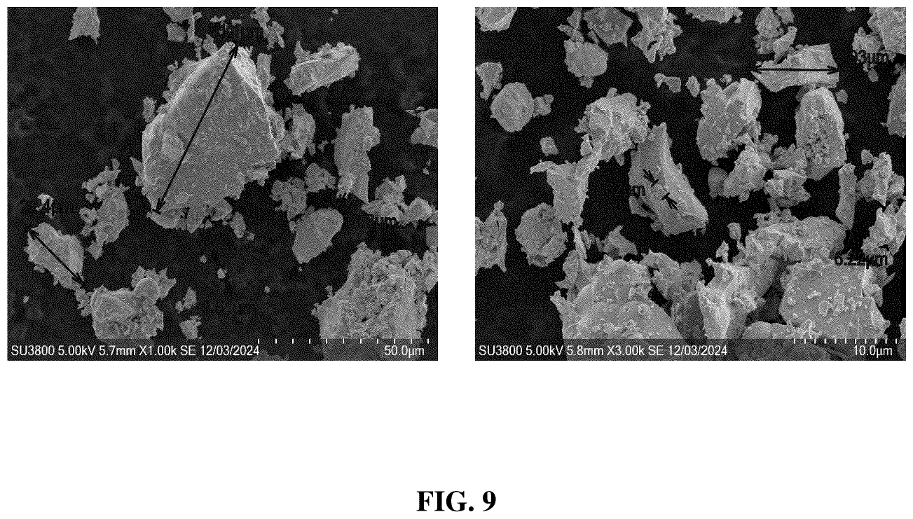

Additionally, particle size analysis demonstrates significant differences between standard and solid-state synthesized materials. The BTO produced by solid-state synthesis exhibits larger particle sizes than typical BTO made via co-precipitation. The final LT structure derived from solid-state BTO also involves larger particles compared to standard LT used in current cells. The median particle size (D50) values for representative samples are:
Standard BTO: D50=14.45 μm
Unmilled Solid-State Synthesized BTO (P2295-1002): D50=190.64 μm. SEM images of this unmilled Solid-State Synthesized BTO are shown in FIG. 9.

This indicates that solid-state synthesized BTO has a significantly larger particle size compared to standard BTO made via co-precipitation.

### For the Final LT Structures:

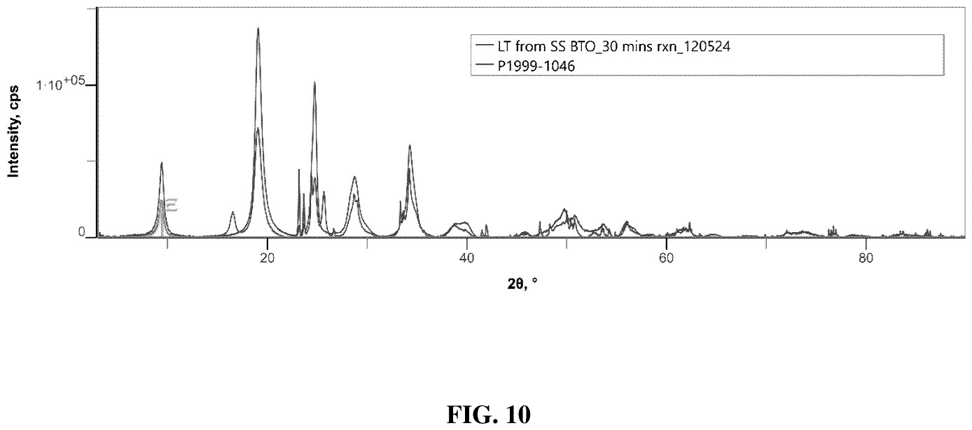

Standard LT: D50=4.21 μm
LT from Unmilled Solid-State Synthesized BTO (P2298-1001): D50=14.94 μm. XRD of LT from Unmilled Solid-State Synthesized BTO is shown in FIG. 10.

The LT produced from unmilled solid-state synthesized BTO is considerably larger than standard LT, confirming that synthesis route impacts particle size and morphology.

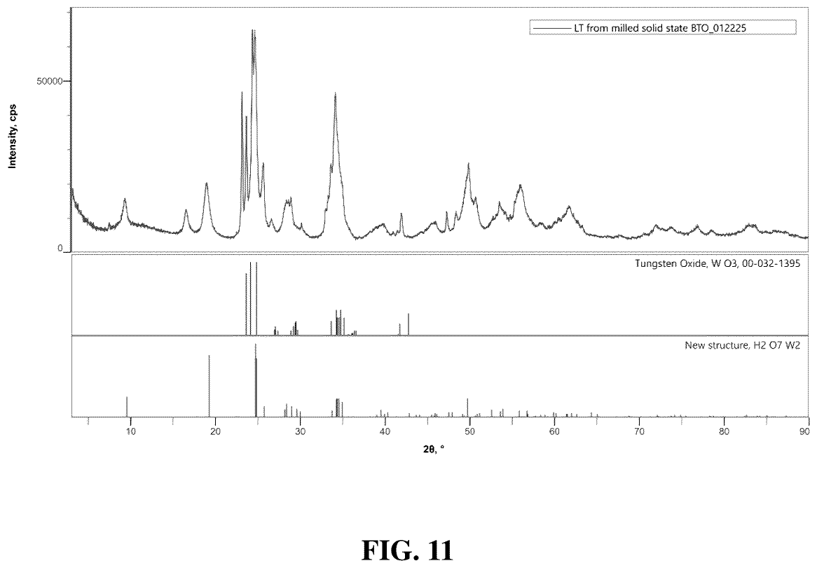

XRD of milled solid state synthesized BTO (P2353-1001), WO₃, and LT are shown in FIG. 11.

TABLE 6
Particle Size Distribution of standard BTO, unmilled
and milled solid-state synthesized BTO

| | | Unmilled Solid-State | Milled Solid-State |
|---|---|---|---|
| | Standard | Synthesized BTO | Synthesized BTO |
| | BTO | (P2295-1002) | (P2343-1001) |
| D10 | 7.74 μm | 10.81 μm | 0.17 μm |
| D50 | 14.45 μm | 190.64 μm | 0.57 μm |
| D90 | 25.74 μm | 606.82 μm | 2.20 μm |

TABLE 7
Particle Size Distribution of standard BTO, unmilled
and milled solid-state synthesized LT

| | | | LT from unmilled | | LT from milled | |
|---|---|---|---|---|---|---|
| | | | Solid State | | Solid State | |
| | | | Synthesized BTO | | Synthesized BTO | |
| | Standard LT | | (P2298-1001) | | (P2353-1001) | |
| D10 | 2.02 | μm | 5.58 | μm | 0.19 | μm |
| D50 | 4.21 | μm | 14.94 | μm | 0.82 | μm |
| D90 | 7.43 | μm | 40.94 | μm | 22.74 | μm |

### Example #8—Milling of BTO to Control Particle Size

In another exemplary embodiment, bismuth tungsten oxide (BTO) produced by solid-state synthesis was further processed using a basket mill to control and adjust the particle size of the material. This milling process provides additional flexibility in tuning the physical characteristics of BTO, which can influence the properties of the final layered tungsten oxide (LT) material obtained after ion-exchange. Specifically, adjusting the particle size of BTO through milling can affect:

Surface Area: Smaller particles exhibit a larger surface area, which may improve ion-exchange efficiency and potentially enhance electrochemical performance in energy storage applications.

Porosity: Particle size distribution may directly impact the porosity of the LT material, influencing its ability to absorb and release ions and its overall structural stability.

Ion Diffusion Rate: Milling can enhance ion diffusion within the material, as smaller particle sizes create more accessible pathways for ion transport through the structure.

### Example #9—Solid-State Synthesis of Bismuth-Tungsten Oxide (BTO) Intermediate

Two powders, one being a bismuth source and the other being a tungsten source such as Bi₂O₃ and WO₃, are mixed and heated to temperatures around 700-850° C. Bi₂O₃ acts both as a reactant and solvent, melting at 817° C. to facilitate diffusion throughout the system. This step is performed under oxygen or air. The temperature and dwell time during this reaction can be varied to affect particle size and surface area of the produced BTO.

This BTO can be further processed into various forms, including powders for direct use in electrodes. In addition to Bi₂O₃ and WO₃, other bismuth-containing compounds may be employed as precursors in the solid-state synthesis step. Suitable bismuth sources include, but are not limited to: BiOCl, Bi(NO₃)₃, Bi₂(SO₄)₃, BiO(NO₃), Bi₂O₃, Bi₂S₃, BiX₃ (where X is a halide), bismuth subsalicylate, or other bismuth containing compounds may be used. Similarly, tungsten sources may include: Ammonium paratungstate, ammonium metatungstate, ammonium tungstate, and/or WOₙ (where n≤3).

### Example #10—Ion Exchange to Produce LT Anode Material

After the solid-state reaction, the BTO from Example #9 is subjected to an ion-exchange process to produce the final LT anode material. The ion-exchange process involves dissolving the BTO in a 6 M HCl solution and heating the mixture to 50° C. for 90 minutes. After the heating period, the mixture is allowed to settle, and the supernatant is decanted. This process is repeated two more times to ensure thorough ion exchange. Finally, the material is washed with water and filtered to obtain the final product.

Ion exchanging BTO synthesized through solid state synthesis results in larger particles and enhanced WO₃ peaks in the LT material compared to standard coprecipitation methods.

### Example #11—Molten Solid-State Synthesis

In this exemplary embodiment, a molten solid-state reaction is utilized at 850° C. where Bi₂O₃ melts. This creates a more efficient and faster synthesis process. In comparison to the typical co-precipitation process, which generally takes around 2 days to complete (including the co-precipitation reaction, filtering, and calcination steps), the molten solid-state synthesis significantly reduces the processing time. In this molten solid-state method, the BTO comes out pre-calcined, with a total process time of under 5 hours. Specifically, the process includes about 170 minutes of ramp-up time (at a rate of 5° C./min), followed by a dwell time of 30 minutes to 120 minutes at 850° C. The shorter overall process time (less than 5 hours) means reduced energy consumption compared to the 2-day co-precipitation process. This contributes to both faster production and lower overall energy usage.

### Example #12—Use of Bi₂O₃ as Reactant and Solvent

Bi₂O₃ may be unique in some embodiments because it functions as both the reactant and solvent, eliminating the need for an external solvent and enhancing the diffusion of materials.

The use of Bi₂O₃ as both a reactant and solvent speeds up the synthesis process, reducing the time and energy required for production. This also removes the need for solvents, making the process more environmentally friendly. Compared to traditional co-precipitation methods, which take approximately 2 days (including co-precipitation, filtering, and calcination steps), the molten solid-state synthesis process is completed in less than 5 hours. This represents time savings of over 80%, with the process being completed in just a few hours instead of days. Moreover, the molten solid-state process eliminates the calcination step, which is traditionally required in co-precipitation methods to achieve the final BTO product. This further reduces both the time and energy consumption associated with the synthesis process.

1. A method of manufacturing an electroactive anode material, the method comprising:
forming a precursor electroactive anode material comprising a first tungsten oxide material; and
performing an ion-exchange process on the precursor electroactive anode material to obtain an electroactive anode material comprising a second tungsten oxide material.

2. The method of claim 1, wherein forming the precursor electroactive anode material comprises performing a solid-state synthesis to obtain the precursor electroactive anode material.

3. The method of claim 2, wherein the solid-state synthesis comprises reacting a first precursor and a second precursor together to form a mixture comprising the precursor electroactive anode material.

4. The method of claim 3, wherein the first precursor is Bi₂O₃ and the second precursor is WO₃.

5. The method of claim 4, wherein the Bi₂O₃ acts as both a reactant and a solvent in the solid-state synthesis.

6. The method of claim 1, wherein forming the precursor electroactive anode material comprises performing a molten solid-state synthesis to obtain the precursor electroactive anode material;
wherein the molten solid-state synthesis is conducted at a temperature in a range of from 700° C. to 900° C.; and
wherein the molten solid-state synthesis is performed over a period of time of no more than 5 hours of process time.

7. The method of claim 2, wherein the solid-state synthesis is performed using BiOCl, Bi(NO₃)₃, Bi₂(SO₄)₃, BiO(NO₃), Bi₂O₃, Bi₂S₃, BiX₃ (where X is a halide), or bismuth subsalicylate and a precursor for tungsten to obtain the first tungsten oxide, wherein the first tungsten oxide is a bismuth tungsten oxide (BTO).

8. The method of claim 1, wherein forming the precursor electroactive anode material comprises performing a co-precipitation to obtain the precursor electroactive anode material.

9. The method of claim 8, wherein the co-precipitation comprises reacting a first precursor together to form a mixture comprising the precursor electroactive anode material.

10. The method of claim 9, wherein the reacting happens at a pH in a range of from 5 to 6.

11. The method of claim 9, wherein the co-precipitation comprises neutralizing the mixture with a base to form a stable mixture comprising the precursor electroactive anode material.

12. The method of claim 11, wherein the base is ammonium hydroxide.

13. The method of claim 11, wherein the co-precipitation further comprises drying the stable mixture to form a dried mixture comprising the precursor electroactive anode material.

14. The method of claim 13, wherein the drying comprises performing a spray drying process.

15. The method of claim 14, wherein the co-precipitation comprises calcination of the dried mixture to obtain the precursor electroactive anode material in a crystalline form.

16. The method of claim 15, wherein the calcination is performed at a temperature in a range of from 700° C. to 850° C.

17. The method of claim 15, wherein the calcination comprises static calcination or rotary calcination.

18. The method of claim 15, wherein the crystalline precursor electroactive anode material comprises flat plate shaped particles.

19. The method of claim 3, wherein the precursor for tungsten comprises ammonium paratungstate, calcium tungstate, sodium tungstate, potassium tungstate, scheelite, wolframite, or a combination thereof.

20. The method of claim 3, wherein the precursor for tungsten comprises ammonium metatungstate, an oxide of tungsten, or a combination thereof.

21. The method of claim 3, wherein the first precursor comprises a metal nitrate, a phosphate, a sulphate, an oxide of lithium, sodium, potassium, calcium, zinc, aluminum, bismuth, molybdenum, cesium, rubidium, titanium, vanadium, chromium, manganese, iron, cobalt, nickel, copper, indium, tin, lead, or a combination thereof.

22. The method of claim 3, wherein the first precursor is Bi₂O₃ and the second precursor is WO₃.

23. The method of claim 9, wherein the first precursor is a bismuth nitrate and the second precursor for tungsten is ammonium paratungstate.

24. The method of claim 1, wherein the first tungsten oxide material is a metal tungsten oxide.

25. The method of claim 24, wherein the metal tungsten oxide is a bismuth tungsten oxide (BTO).

26. The method of claim 1, wherein the ion-exchange process comprises subjecting the precursor electroactive anode material to ion exchange using a strong acid to form solid particles of the electroactive anode material.

27. The method of claim 26, wherein the HCl has a concentration in a range of from 1 molar to 15 molar.

28. The method of claim 26, wherein the ion-exchange process comprises drying the solid particles at a temperature in a range of from 50° C. to 150° C.

29. The method of claim 28, wherein the ion-exchange process comprises sieving the solid particles after drying.

30. The method of claim 29, wherein the solid particles after sieving have a particle size distribution characterized by a D50 in a range of from 170 μm to 210 μm.

31. The method of claim 1, wherein the ion-exchange process comprises three sequential ion-exchange steps.

32. The method of claim 31, wherein each of the ion-exchange steps is performed at a temperature in a range of from 40° C. to 60° C.

33. The method of claim 1, wherein the second tungsten oxide material is H₂W₂O₇ (LT).

34. The method of claim 1, wherein the electroactive anode material comprises particles comprising the second tungsten oxide material and having a particle size distribution characterized by a D50 in a range of from of 10 μm to 30 μm.

35. The method of claim 1, comprising forming an electrode comprising the electroactive anode material and one or more conductive additives and/or one or more binders.

36. The method of claim 35, comprising disposing the electrode on an electrically conducting current collector.

37. The method of claim 3, wherein the method further comprises recovering a first precursor from a post-ion-exchange waste stream.

38. The method of claim 1, wherein forming the precursor electroactive active material is performed using a first precursor and a second precursor and the first precursor is a bismuth oxide or bismuth oxychloride.

39. The method of claim 38, wherein the first precursor is bismuth oxychloride.

40. The method of claim 38, wherein the first precursor is a recycled material.

41. The method of claim 38, comprising recovering the bismuth oxide or bismuth oxychloride from a waste stream of an ion-exchange process.

42. The method of claim 1, wherein the ion-exchange process is a continuous process comprising an inline filter.

43. A composition comprising the electroactive anode material produced by the method of claim 1, wherein the electroactive anode material comprises H₂W₂O₇.

44. An electrode comprising the composition of claim 43.

45. An electrochemical cell comprising the electrode of claim 44.

46. An anode in an energy storage device comprising the composition of claim 43.

47. The composition of claim 43, wherein the electroactive anode material is in form of a powder.

48. A method of manufacturing an electroactive anode material, the method comprising:
forming a precursor electroactive anode material comprising a first tungsten oxide material using one or more recycled precursor materials; and
performing an ion-exchange process on the precursor electroactive anode material to obtain an electroactive anode material comprising a second tungsten oxide material.

49. The method of claim 48, wherein the one or more recycled precursor materials comprises a metal oxychloride.

50. The method of claim 48, wherein forming the precursor electroactive anode material is performed using one or more non-recycled precursor materials.

51. The method of claim 48, wherein the first tungsten oxide material is bismuth tungsten oxide.

52. The method of claim 48, wherein the second tungsten oxide material is H₂W₂O₇ (LT).

53. The method of claim 48, comprising obtaining the one or more recycled precursor materials from a waste stream of an ion-exchange process.

54. The method of claim 48, comprising obtaining one or more recycled precursor materials from a waste stream of the ion-exchange process.

55. The method of claim 54, comprising forming a second precursor electroactive anode material using the one or more recycled precursor materials.

56. The method of claim 48, comprising iteratively performing the forming and performing steps using byproduct material obtained from a waste stream of the ion-exchange process in one iteration of the performing step as at least one of the one or more recycled precursor materials in a subsequent iteration of the forming step.
